(19) United States
(12) Patent Application Publication
(10) Pub. No.: US 2005/0266231 A1
(43) Pub. Date: Dec. 1, 2005

(54) Heat sink for a display monitor

(75) Inventor: Yu-Kai Lin, Hsinchu City (TW)

Correspondence Address: BIRCH STEWART KOLASCH & BIRCH, PO BOX 747, FALLS CHURCH, VA, 22040-0747, US

(73) Assignee: AU Optronics Corp.

(21) Appl. No.: 10/992,842

(22) Filed: Nov. 22, 2004

(30) Foreign Application Priority Data
May 28, 2004 (TW) 93208447

(51) Int. Cl. B32B 3/26

(52) U.S. Cl. 428/317.9; 428/319.1; 428/156; 428/157; 361/704

(57) ABSTRACT

A display monitor includes a heat source, a metal frame and a heat sink disposed between the heat source and the metal frame in order to lower ambient temperature. The heat sink includes a metal layer and a sandwiching pad disposed on the metal layer. The sandwiching pad is made from a material doped with conductive powders.

### FIELD OF THE INVENTION

The invention relates to a heat sink, and more particularly to an effective heat sink for used in a display monitor, such as liquid crystal display (LCD) devices, a plasma TV set or an illumination device.

### BACKGROUND OF THE INVENTION

In a conventional CRT-type T V set, a gun continuously fires a beam of electrons inside a large glass tube to excite the phosphor atoms and causes the phosphor atoms to light up. When different areas of the phosphor coating are lit up with different colors at different intensities, an image is consequently produced. Due to its bulky size, the conventional CRT TV set is rapidly replaced by plasma TVs or LCD devices by virtue of its compact size and its portability.

It is noted that in an LCD device or a plasma TV set, a backlight (which generates heat) is disposed behind a display screen to illuminate the latter. Referring to FIG. 1, a partly perspective view of a conventional LCD monitor 10 is shown to include a heat source (preferably a backlight or a cold cathode fluorescent lamp) 12, a metal frame 14 disposed rearward of the heat source 12 to protect the same from a rearward collision, and a heat sink 16 disposed between the heat source 12 and the metal frame 14 in order to transfer the heat generated from the heat source 12 to the metal frame 14 so as lower the ambient temperature of the whole assembly. Of course, the display screen is disposed frontward of the heat source 12. To display an image on the display screen, an electrical voltage is applied onto two electrode layers at opposite ends of the liquid crystal layer in a pixel unit of the conventional LCD monitor in order to convert the orientation of the crystal molecules in the liquid crystal layer. During conversion of the electrical energy into the light energy, heat is generally generated to increase the ambient temperature of the heat source. Since the performance of the LCD monitor increases, the heat generated therefrom consequently is relatively large. In case the heat is not efficiently dissipated from the LCD monitor, the service life and its functionality and quality thereof will be affected.

FIG. 2 is a schematic cross-sectional view showing the structure of the heat sink 16 used in the conventional LCD monitor and is manufactured according to the method disclosed in U.S. patent application publication No. 2002/0011660, titled “Heat sink sheet and fabrication method therefore”. As illustrated, the heat sink 16 includes a silicon heat sink layer 161 doped with metal powders 163, and two pressure sensitive_adhesion layers 165 disposed at opposite sides of the silicon heat sink layer 161. The pressure sensitive adhesion layers 165 serve the role of securing the heat sink layer 161 between a heat source, such as electronic equipment, and a heat sink, such as an aluminum-cooling fin.

### SUMMARY OF THE INVENTION

One object of the present invention is to provide a heat sink for a display monitor, such as an LCD monitor or plasma TV set. The heat sink thereof provides high effective heat dissipating performance.

In one aspect of the present invention, a display monitor is provided to include: a heat source; a metal frame disposed rearward of the heat source; and a heat sink disposed between the heat source and the metal frame in order to transfer heat generated from the heat source to the metal frame so as to lower ambient temperature of the heat source. The heat sink includes a sandwiching pad made from a material doped with conductive powders and a metal layer disposed on the sandwiching pad.

In another aspect of the present invention, a heat sink is proposed for a display monitor which includes a heat source and a metal frame disposed rearward of the heat source. The heat sink is disposed between the heat source and the metal frame in order to transfer heat generated from the heat source to the metal frame so as to lower ambient temperature of the heat source. The heat sink includes: first and second sandwiching pads made from a material doped with conductive powders; and a first metal layer disposed therebetween so as to be sandwiched by the first and second sandwiching pads.

### BRIEF DESCRIPTION OF THE DRAWINGS

Other features and advantages of this invention will become more apparent in the following detailed description of the preferred embodiments of this invention, with reference to the accompanying drawings, in which:

FIG. 1 is a partly perspective view of a conventional LCD monitor;

FIG. 2 is a schematic cross-sectional view showing the structure of the heat sink used in the conventional LCD monitor;

FIG. 3 is a partly exploded perspective view of a heat sink of an LCD monitor according to the preferred embodiment of the present invention;

FIG. 4A is a partly perspective view of the LCD monitor of the present invention;

FIG. 4B is a graph showing the comparison of the heat sinks used in the conventional and present LCD monitors;

FIG. 5 shows a partly exploded perspective view of a modified heat sink employed in the LCD monitor of the present invention;

FIG. 6 shows a partly exploded perspective view of another modified heat sink employed in the LCD monitor of the present invention; and

FIG. 7 shows a partly exploded perspective view of a still modified heat sink employed in the LCD monitor of the present invention.

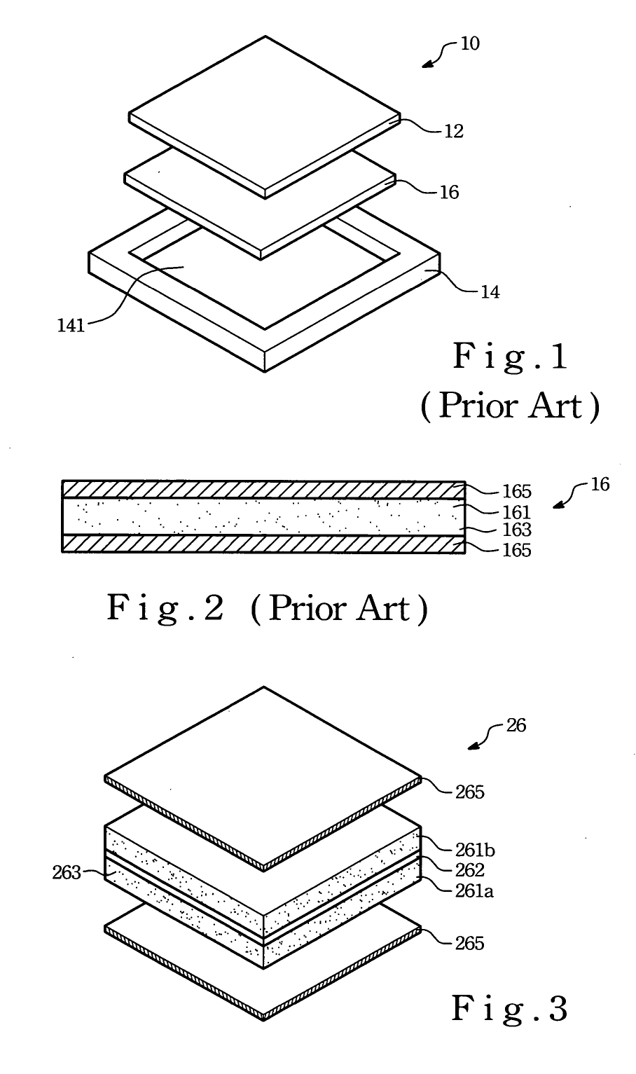

### DETAILED DESCCRIPTIONS OF THE PREFERRED EMBODIMENTS

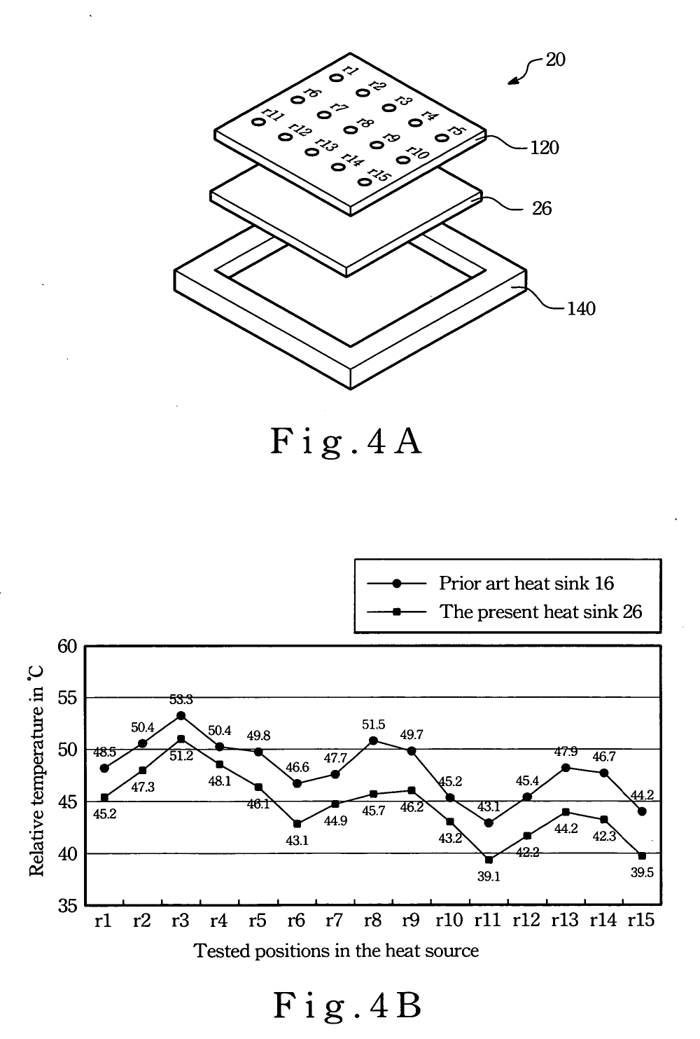

Referring to FIG. 4A, a partly perspective view of an LCD monitor 20 according to the present invention is shown to include a heat source 120, a metal frame 140 disposed rearward of the heat source 120 to protect the latter from a rearward collision, and a heat sink 26 disposed between the heat source 120 and the metal frame 140 in order to transfer heat generated from the heat source 120 to the metal frame 140 so as lower the ambient temperature of the whole assembly. The heat source 120 may be a backlight or a cold cathode fluorescent lamp. Of course, a display screen (not shown) of the LCD monitor is disposed frontward of the heat source 120 for displaying an image. Since the relevant feature of the present invention does not reside in the structures of the display screen, a detailed structure thereof is omitted herein for the sake of brevity.

FIG. 3 is a partly exploded and perspective view of the heat sink 26 employed in the LCD monitor of the present invention, and includes first and second sandwiching pads 261a, 261b and a first metal layer 262 sandwiched between the first and second sandwiching pads 261a, 261b. The first metal layer 262 can be one of the metal materials having high heat conductivity, such as aluminum or copper. Each of the first and second sandwiching pads 261a, 261b can be made from a soft polymeric substance doped with conductive powers 263, such as aluminum powder or copper powder, and silicon polymer fillers such that upon receipt of an applied pressure, the density of each of the first and second sandwiching pads 261a, 261b is increased. The increased density in the first and second sandwiching pads 261a, 261b consequently results in high heat conductivity effect, thereby enhancing the heat dissipating ability of the first and second sandwiching pads 261a, 261b. Of course, two-sided adhesion layers 265 are disposed on the outer surfaces of the first and second sandwiching pads 261a, 261b respectively to facilitate mounting of the heat sink 26 onto the heat source 120 and the mounting side of the metal frame 140 (see FIG. 4A).

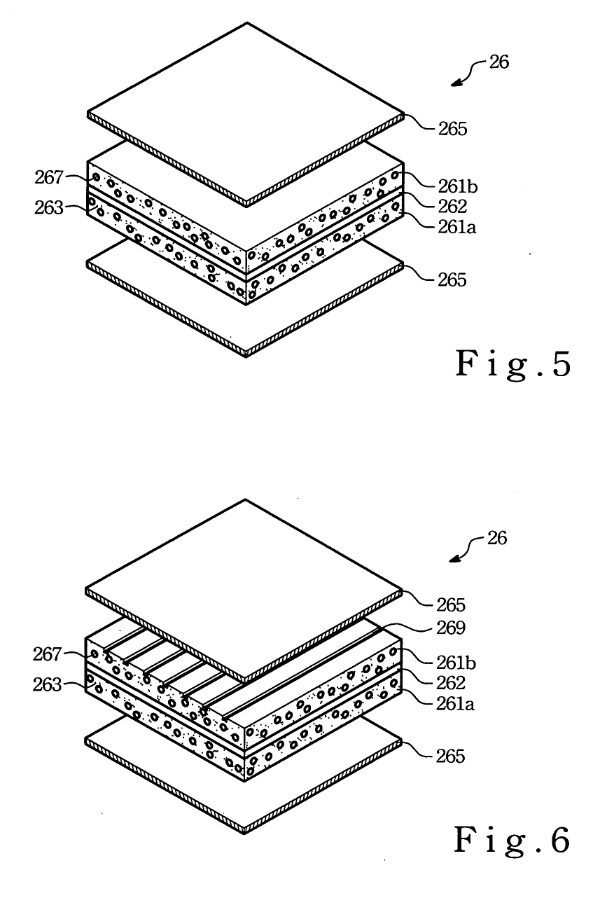

Referring to FIG. 5, a modified heat sink 26 employed in the LCD monitor of the present invention is shown to have the structure similar to the previous embodiment. The difference resides in that each of the first and second sandwiching pads 261a, 261b is a foamed member formed with a plurality of evenly distributed bubbled portions 267. When pressure is applied onto the outer surfaces of the foamed members, the air entrapped within the bubbled portions 267 will be expelled therefrom, thereby resulting in the increased density in each of the foamed members so as to enhance the heat dissipating operation thereof.

Referring to FIG. 6, an another modified heat sink 26 employed in the LCD monitor of the present invention is shown to have the structure similar to that in FIG. 5. The difference resides in that each of the foamed members has an outer surface formed with a plurality of parallel grooves 269, and a plurality of evenly distributed bubbled portions 267 which are located inwardly with respect to the parallel groove 269. When pressure is applied onto the outer surfaces of the foamed members, the air entrapped within the bubbled portions 267 will be expelled therefrom via the parallel grooves 269, thereby resulting in the increased density of each of the foamed members to enhance heat dissipating operation thereof.

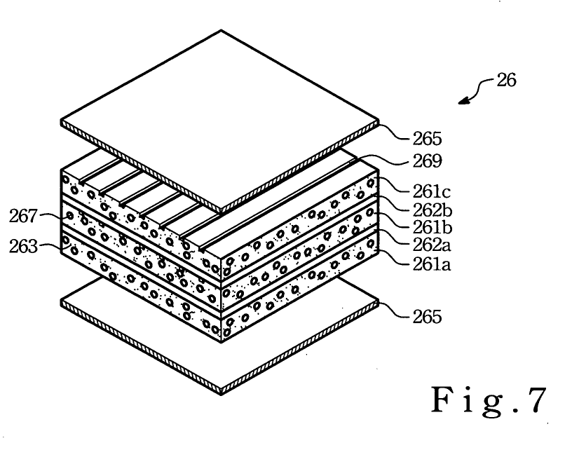

Referring to FIG. 7, a still another modified heat sink 26 employed in the LCD monitor of the present invention is shown to have the structure similar to those shown in FIGS. 5 and 6. The difference resides in that a third sandwiching pad 261c made also from the soft polymeric substance and doped with conductive powders is disposed adjacent to the second sandwiching pad 261b. A second metal layer 262b is sandwiched between the second and third sandwiching pads 261b, 261c. The second metal layer 262b can be one of the metal materials having high heat conductivity, such as aluminum or copper.

According to the present invention, two experiments were conducted to test the temperatures, one for the prior art heat sink 16 and the other for the present heat sink 26 used in the LCD monitor of the present invention under the conditions that no composite material is altered and each of the heat sinks 16, 26 has the same total thickness. The temperatures of different tested positions (r1, r2, . . . , r15) (please see FIG. 4A) in the heat source 120 by alternate employment of the prior art heat sink 16 and the present heat sink 26, are recorded respectively and are compared relative to each other.

FIG. 4B illustrates two graphs respectively representing the tested positions in the heat source 120 and its relative temperatures of the prior art heat sink 16 and the present heat sink 26. From the above-mentioned graphs, one can observe the heat dissipating ranges of the prior art heat sink 16 and those of the present heat sink 26. It is noted that the present heat sink 26 provides high heat dissipating effect by virtue of its structure and due to the increased density of the sandwiching pads caused by the applied pressure. Generally, the present heat sink 26 can lower 3.5° C., as compared to the prior art heat sink 16.

While the present invention has been described in connection with preferred embodiments, it is understood that this invention is not limited to the disclosed embodiments but is intended to cover various arrangements included within the spirit and scope of the broadest interpretation so as to encompass all such modifications and equivalent arrangements.

1. A heat sink for a display monitor, comprising:
a first sandwiching pad doped with conductive powders; and
a first metal layer disposed on said first sandwiching pad.

2. The heat sink according to claim 1, wherein said sandwiching pad is further doped with soft silicon polymeric substance.

3. The heat sink according to claim 1, wherein said sandwiching pad is a foamed member formed with a plurality of bubbled portions.

4. The heat sink according to claim 1, wherein said sandwiching pad is a foamed member having an outer surface formed with a plurality of parallel grooves.

5. The heat sink according to claim 2, wherein said sandwiching pad is a foamed member having an outer surface formed with a plurality of parallel grooves, said foamed member further being formed with a plurality of evenly distributed bubbled portions located inwardly with respect to said parallel grooves.

6. A heat sink for a display monitor which includes a heat source and a metal frame disposed rearward of the heat source, the heat sink being disposed between the heat source and the metal frame, the heat sink comprising:
a first sandwiching pad doped with conductive powder;
a second sandwiching pad doped with conductive powder; and
a first metal layer disposed between said first and said second sandwiching pads.

7. The heat sink according to claim 6, wherein said first and said second sandwiching pads are further doped with silicon polymeric substance.

8. The heat sink according to claim 6, wherein each of said first and second sandwiching pads is a foamed member formed with a plurality of bubbled portions.

9. The heat sink according to claim 6, wherein each of said first and second sandwiching pads is a foamed member having an outer surface formed with a plurality of parallel grooves.

10. The heat sink according to claim 9, further comprising a plurality of evenly distributed bubbled portions located inwardly with respect to said parallel grooves.

11. The heat sink according to claim 6, wherein said second sandwiching pad is a foamed member having an outer surface formed with a plurality of parallel grooves, and a plurality of evenly distributed bubbled portions located inwardly with respect to said parallel grooves.

12. The heat sink according to claim 6, further comprising a third sandwiching pad disposed adjacent to said second sandwiching pad, and a second metal layer sandwiched between said second and third sandwiching pads.

13. The heat sink according to claim 12, wherein said third sandwiching pad is doped with conductive powder.
